(19) United States
(12) Patent Application Publication
(10) Pub. No.: US 2004/0120300 A1
(43) Pub. Date: Jun. 24, 2004

(54) System, method and apparatus for parallel information transmission in wireless communication systems

(75) Inventor: Mohammad Saquib, Carrollton, TX (US)

Correspondence Address: CHALKER FLORES, LLP, 12700 PARK CENTRAL, STE. 455, DALLAS, TX, 75251, US

(73) Assignee: Board Of Regents, The University Of Texas System, Austin, TX

(21) Appl. No.: 10/727,064

(22) Filed: Dec. 2, 2003

Related U.S. Application Data
(60) Provisional application No. 60/430,410, filed on Dec. 2, 2002.

(51) Int. Cl. H04B 7/216

(52) U.S. Cl. 370/342; 370/347; 370/335; 375/230; 375/232

(57) ABSTRACT

The present invention provides a system, method and apparatus for parallel information transmission in wireless communication systems. More specifically, the present invention provides a method of transmitting information over a transmission medium by receiving a set of serial symbols or bits representing the information to be transmitted during a frame (502), encoding the set of serial symbols or bits into one or more sets of parallel channel symbols or bits (504), and transmitting the one or more sets of parallel channel symbols or bits the frame (506). The present invention also provides a method of receiving information over a transmission medium by receiving a set of parallel channel symbols or bits during a frame (1302) and decoding the set of parallel channel symbols or bits into a set of serial symbols or bits representing the information transmitted (1304).

### FIELD OF THE INVENTION

The present invention relates generally to the field of communications and, more particularly, to a system, method and apparatus for parallel information transmission in wireless communication systems.

### BACKGROUND OF THE INVENTION

Future wireless systems are expected to support voice telephony as well as various types of high data rate image and video services. However, the capacity of a wireless system is subject to bandwidth constraints, multipath radio channels, as well as temporal and spatial variation in data traffic. Physical limitations due to multipath fading and interference in wireless channels present a fundamental technical challenge to reliable communication. This limiting factor makes the wireless channel a narrow pipeline that hinders the data flow in the channel.

For example, FIG. 1 depicts a transmitted frame 100 and a received frame 120 in accordance with the prior art. Transmitted frame 100 contains n bits or symbols of information that are transmitted in serial over a communications channel 114: bit 0 (102) followed by bit 1 (104), followed by bit 2 (106), followed by bit 3 (108), followed by bit 4 (110), followed by bit 5 (112), and so on. Received frame 120 also contains n bits or symbols of information of varying magnitude caused by multipath fading, interference and other environmental factors. As illustrated, received bits 0 (122) and 1 (124) are only slightly reduced in magnitude from transmitted bits 0 (102) and 1 (104). Received bits 2 (126) and 3 (128), on the other hand, are so reduced in magnitude from transmitted bits 2 (106) and 3 (108) that they cause an error in the received frame 120. Received bits 4 (130) and 5 (132) are moderately reduced in magnitude from transmitted bits 4 (110) and 5 (112).

Various techniques have been introduced to overcome the problems of multipath fading and interference, such as space-time diversity using two transmit antennas and Orthogonal Frequency Division Multiplexing (OFDM). For example, FIG. 2 depicts a two transmitter diversity scheme 200 in accordance with the prior art. Using this scheme 200, information, such as bit 0 (202), is transmitted over antenna 1 (204) and antenna 2 (206) as channels 1 (208) and 2 (210), respectively. The physical separation of antenna 1 (204) and antenna 2 (206) provides space diversity. As a result, bit 0 (212) transmitted over channel 1 (208) and bit 0 (214) transmitted over channel 2 (210) will arrive at the receiver with different magnitudes, which increases the probability that the receiver will properly receive and decode the information. These systems are, however, costly and complex. Moreover, these techniques cannot be implemented in every situation. Accordingly, there is a need for a simple cost efficient system to overcome the problems of multipath fading and interference in a wireless communication system.

### SUMMARY OF THE INVENTION

The present invention provides a simple cost efficient system to overcome the problems of multipath fading and interference in a wireless communication system by using parallel bit or symbol transmission techniques. More specifically, the present invention provides a parallel bit transmission scheme wherein bits of a user are spread over several sub-frames (or over the whole frame). In a time varying channel, the present invention efficiently exploits the temporal and frequency diversities of CDMA systems. Temporal diversity results from the parallel bit transmission and frequency diversity is an inherent property of the CDMA system. An OFDM system, however, is very sensitive to the rapid variation in the channel due to the inter-carrier-interference (ICI). When the channel is slowly varying and feedback between transmitter and receiver is feasible, the present invention solves a joint transmitter-receiver optimization problem by minimizing the sum of the transmitter power by the system subject to users' signal-to-interference ratio (SIR) requirements. The present invention can be implemented in a conventional CDMA system or the OFDM system by the proper choice of signatures.

The present invention also works in a variety of system circumstances, such as bit synchronous parallel CDMA system, multipath parallel CDMA system and parallel CDMA system with multiple transmitting antennas at the transmitters. A user experiences almost similar average interference at the output of the matched filter in both the conventional and parallel CDMA (present invention) systems. The present invention provides higher received energy at the matched filter output than the conventional CDMA system with high probability. The present invention is capable of yielding more than six times the capacity of the conventional CDMA system.

The present invention also allows a receiver to come to all bits' decisions even before receiving the entire frame. In such cases, the transmitter may go into sleep mode until the next transmission time, or the transmitter may start transmitting the next available frame in the queue. This decreases the interference in the system and/or increases the system throughput. Thus, the present invention introduces the notion of “soft frame length” in the wireless systems. The length of the frame will depend on the duration of its transmission time rather than the number of bits in it. Using this soft frame length concept, several signal processing aided frame transmission protocols can be used.

When the space-time codes are implemented in the present invention (parallel CDMA system), the diversity gain of the space-time code increases with the number of independent fades within the frame. Besides the above, many unique properties, such as the feasibility of distributed power control algorithms, simplification of channel estimation process, easy implementation of non-coherent detection, robustness to multipath fading, interference suppression capability etc. are identified to be inherent to the present invention (parallel CDMA system).

More specifically, the present invention provides a method of transmitting information over a transmission medium by receiving a set of serial symbols or bits representing the information to be transmitted during a frame, encoding the set of serial symbols or bits into one or more sets of parallel channel symbols or bits, and transmitting the one or more sets of parallel channel symbols or bits the frame.

The present invention also provides a method of transmitting information over a transmission medium by receiving a set of serial bits and encoding the set of serial bits into a set of serial symbols representing the information to be transmitted during the frame. The set of serial symbols are then converted into one or more sets of parallel symbols. Thereafter, the one or more sets of parallel symbols are encoded into a transmission channel and the one or more sets of parallel channel symbols are transmitted during the frame.

In addition, the present invention provides an apparatus for transmitting information over a transmission medium. The includes an encoder, a serial to parallel symbol converter communicably coupled to the encoder, a modulator communicably coupled to the serial to parallel symbol converter, and one or more antennas communicably coupled to the modulator. The encoder produces a set of serial symbols that represent the information to be transmitted during the frame from a set of serial bits. The serial to parallel symbol converter produces one or more sets of parallel channel symbols from the set of serial symbols.

Moreover, the present invention provides a method of receiving information over a transmission medium by receiving a set of parallel channel symbols or bits during a frame and decoding the set of parallel channel symbols or bits into a set of serial symbols or bits representing the information transmitted.

The present invention also provides a method of receiving information over a transmission medium by receiving a set of parallel channel symbols or bits during a frame in and observing the received set of parallel channel symbols or bits over an interval of the frame. The received set of parallel channel symbols or bits are then decoded into a set of serial symbols or bits representing the information transmitted. If the information was not correctly received, the process observes the received set of parallel channel symbols over another interval of the frame, decodes the received set of parallel channel symbols and again determines if the information was correctly received.

In addition, the present invention provides an apparatus for receiving information over a transmission medium. The apparatus includes one or more antennas, a demodulator communicably coupled to the one or more antennas, a parallel to serial symbol converter communicably coupled to the demodulator and a decoder communicably coupled to the parallel to serial symbol converter. The parallel to serial symbol converter produces a set of serial symbols from the received set of parallel symbols. The decoder produces a set of serial bits representing the information transmitted during a frame from the set of serial symbols. In one embodiment of the present invention, the decoder (a) observes the received serial symbols over an interval of the frame, (b) decodes the serial symbols into a set of serial bits representing the information transmitted, (c) determines whether the information transmitted was received correctly, and observes the received serial symbols over another interval of the frame and repeats steps (b) and (c) whenever the information transmitted was not received correctly. The apparatus may also notify the transmitter that the information transmitted was received correctly whenever the information transmitted was received correctly or alternatively sleep until the next frame whenever the information transmitted was received correctly.

Furthermore, the present invention provides a system for transmitting and receiving information. The system includes a transmitter, a receiver and a transmission medium communicably coupling the transmitter and the receiver. The transmitter includes an encoder that produces one or more sets of parallel channel symbols from a set of serial symbols representing the information to be transmitted during a frame, a serial to parallel symbol converter communicably coupled to the encoder, a modulator communicably coupled to the serial to parallel symbol converter and one or more antennas communicably coupled to the modulator. The receiver includes one or more antennas, a demodulator communicably coupled to the one or more antennas, a parallel to serial symbol converter communicably coupled to the demodulator and a decoder communicably coupled to the parallel to serial symbol converter to produce a set of serial bits representing the information transmitted during the frame.

Note that each of the methods described above can be implemented as a computer program embodied on a computer readable medium wherein each step represents one or more code segments of the computer program. In addition and in each method, apparatus or system described above, the length of the frame will depend on a transmission time rather than the number of symbols or bits in the frame. Moreover, the length of the frame can be variable, based on the successful receipt of the channel symbols or bits by the receiver, based on feedback from the receiver, or some other estimation technique. Furthermore the transmission medium can be a cellular network, a wireless network, an ultra-wide bandwidth (UMB) wireless network or an indoor wireless network and can use any multiplexing scheme, such as TDMA, CDMA or OFDM, etc.

Other features and advantages of the present invention will be apparent to those of ordinary skill in the art upon reference to the following detailed description taken in conjunction with the accompanying drawings.

### BRIEF DESCRIPTION OF THE DRAWINGS

The above and further advantages of the invention may be better understood by referring to the following description in conjunction with the accompanying drawings, in which:

FIG. 1 depicts a transmitted frame and a received frame in accordance with the prior art;

FIG. 2 depicts a two transmitter diversity scheme in accordance with the prior art;

FIG. 3 depicts a transmitted frame and a received frame in accordance with the present invention;

FIG. 4 depicts a virtual space diversity scheme in accordance with the present invention;

FIG. 5 is a flowchart illustrating a method of transmitting information over a transmission medium in accordance with one embodiment of the present invention;

FIG. 6 is a flowchart illustrating a method of transmitting information over a transmission medium in accordance with another embodiment of the present invention;

FIG. 7 is a block diagram of a transmitter is accordance with one embodiment of the present invention;

FIG. 8 is a block diagram of a transmitter is accordance with another embodiment of the present invention;

FIGS. 9A and 9B are graphs of empirical results comparing the present invention to a prior art system;

FIG. 10 depicts a demodulator of DPSK signals in accordance with the present invention;

FIG. 11 depicts the 4PSK constellation points and the four-state, 4PSK space-time trellis code in accordance with the present invention;

FIG. 12 is a graph comparing the performance of the present invention to a prior art system;

FIG. 13 is a flowchart illustrating a method of receiving information over a transmission medium in accordance with one embodiment of the present invention;

FIG. 14 is a flowchart illustrating a method of receiving information over a transmission medium in accordance with another embodiment of the present invention;

FIG. 15 depicts the early frame detection concept for a receiver in accordance with the present invention; and

FIG. 16 depicts a block diagram of a receiver in accordance with the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

The present invention provides a simple cost efficient system to overcome the problems of multipath fading and interference in a wireless communication system by using parallel bit or symbol transmission techniques. More specifically, the present invention provides a parallel bit transmission scheme wherein bits of a user are spread over several sub-frames (or over the whole frame). In a time varying channel, the present invention efficiently exploits the temporal and frequency diversities of CDMA systems. Temporal diversity results from the parallel bit transmission and frequency diversity is an inherent property of the CDMA system. An OFDM system, however, is very sensitive to the rapid variation in the channel due to the inter-carrier-interference (ICI). When the channel is slowly varying and feedback between transmitter and receiver is feasible, the present invention solves a joint transmitter-receiver optimization problem by minimizing the sum of the transmitter power by the system subject to users' signal-to-interference ratio (SIR) requirements. The present invention can be implemented in a conventional CDMA system or the OFDM system by the proper choice of signatures.

The present invention also works in a variety of system circumstances, such as bit synchronous parallel CDMA system, multipath parallel CDMA system and parallel CDMA system with multiple transmitting antennas at the transmitters. A user experiences almost similar average interference at the output of the matched filter in both the conventional and parallel CDMA (present invention) systems. The present invention provides higher received energy at the matched filter output than the conventional CDMA system with high probability. The present invention is capable of yielding more than six times the capacity of the conventional CDMA system.

The present invention also allows a receiver to come to all bits' decisions even before receiving the entire frame. In such cases, the transmitter may go into sleep mode until the next transmission time, or the transmitter may start transmitting the next available frame in the queue. This decreases the interference in the system and/or increases the system throughput. Thus, the present invention introduces the notion of “soft frame length” in the wireless systems. The length of the frame will depend on the duration of its transmission time rather than the number of bits in it. Using this soft frame length concept, several signal processing aided frame transmission protocols can be used.

When the space-time codes are implemented in the present invention (parallel CDMA system), the diversity gain of the space-time code increases with the number of independent fades within the frame. Besides the above, many unique properties, such as the feasibility of distributed power control algorithms, simplification of channel estimation process, easy implementation of non-coherent detection, robustness to multipath fading, interference suppression capability etc. are identified to be inherent to the present invention (parallel CDMA system).

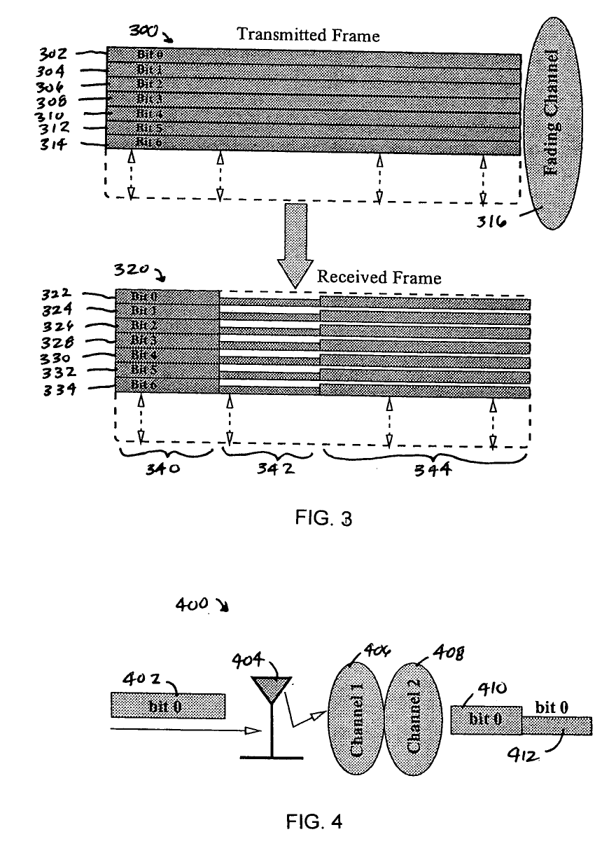

Referring now to FIG. 3, a transmitted frame 300 and a received frame 320 in accordance with the present invention are shown. Transmitted frame 300 contains n bits or symbols of information that are transmitted in parallel over a communications channel 316: bit 0 (302), bit 1 (304), bit 2 (306), bit 3 (308), bit 4 (310), bit 5 (312), bit 6 (314) and so on. All of the bits 302-314 are transmitted in parallel during then length of transmitted frame 300. Received frame 320 also contains n bits or symbols of information that vary in magnitude over the length of the frame 302 as a result of multipath fading, interference and other environmental factors. As illustrated, all of the received bits [bit 0 (322), bit 1 (324), bit 2 (326), bit 3 (328), bit 4 (330), bit 5 (332) and bit 6 (334)] have the same magnitude at any given point in the frame 320. For example, received bits 0-5 (322-334) over the first time period 340 are only slightly reduced in magnitude from transmitted bits 0-5 (302-314). Received bits 0-5 (322-334) over the second time period 342, on the other hand, are so reduced in magnitude from transmitted bits 0-5 (302-314) that they cause an error in any prior art system. Received bits 0-5 (322-334) over third time period 344 are moderately reduced in magnitude from transmitted bits 0-5 (302-314). As a result, all of the transmitted bits 0-5 (302-314) will be correctly received during at least one given time period within received frame 320.

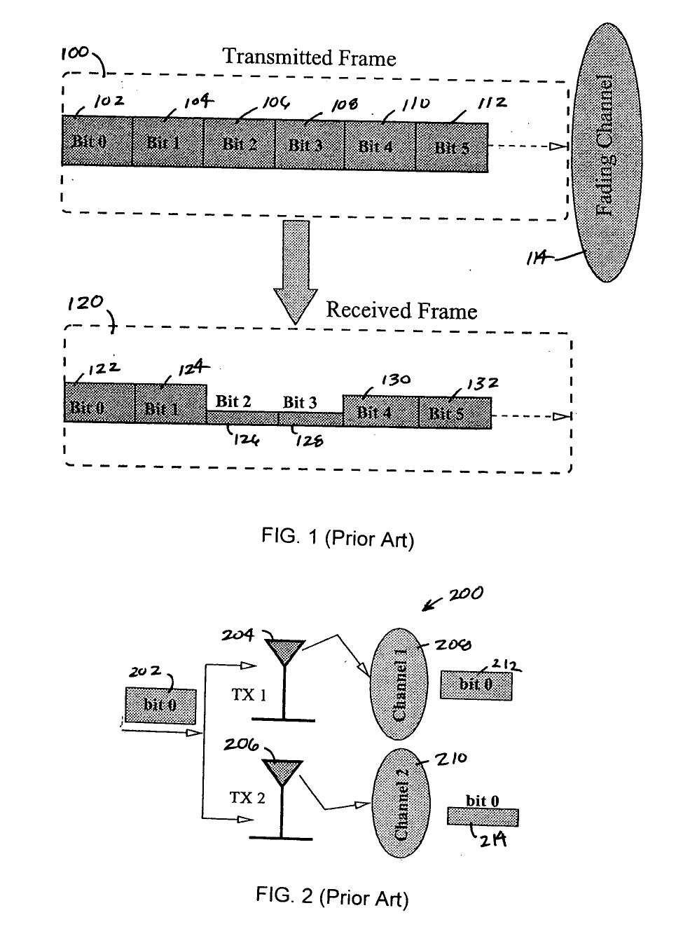

Now referring to FIG. 4, a virtual space diversity scheme 400 in accordance with the present invention is shown. In contrast to the prior art scheme shown in FIG. 2, the present invention can accomplish the same or better results using only one antenna. Using this scheme 400, information, such as bit 0 (402), is transmitted over antenna 404 as channels 1 (408) and 2 (408), respectively. Transmitting the same bits over the entire length of the frame achieves the same or better results as space diversity, which can be referred to as virtual space diversity. As a result, bit 0 (410) transmitted over channel 1 (408) and bit 0 (412) transmitted over channel 2 (408) will arrive at the receiver with different magnitudes, which increases the probability that the receiver will properly receive and decode the information.

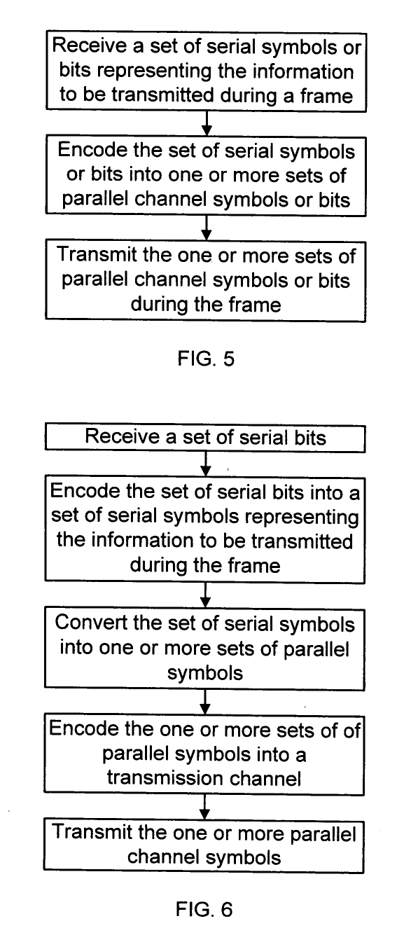

Referring now to FIG. 5, a flowchart 500 illustrating a method of transmitting information over a transmission medium is shown. The method 500 begins in block 502 where a set of serial symbols or bits representing the information to be transmitted during a frame are received. The set of serial symbols or bits are encoded into one or more sets of parallel channel symbols or bits in block 504 and the one or more sets of parallel channel symbols or bits are transmitted during the frame in block 506. Note that this method can be implemented as a computer program embodied on a computer readable medium wherein each block is represents one or more code segments of the computer program. The length of the frame will depend on a transmission time rather than the number of symbols or bits in the frame. In addition, the length of the frame can be variable, based on the successful receipt of the channel symbols or bits by the receiver, based on feedback from the receiver, or some other estimation technique. Note that the transmission medium can be a cellular network, a wireless network, an ultra-wide bandwidth (UMB) wireless network or an indoor wireless network and can use any multiplexing scheme, such as TDMA, CDMA or OFDM, etc.

Now referring to FIG. 6, a flowchart 600 illustrating a method of transmitting information over a transmission medium is shown. The method 600 begins in block 602 where a set of serial bits are received. The set of serial bits are encoded into a set of serial symbols representing the information to be transmitted during the frame in block 604 and the set of serial symbols are converted into one or more sets of parallel symbols in block 606. The one or more sets of parallel symbols are encoded into a transmission channel in block 608 and the one or more sets of parallel channel symbols are transmitted during the frame in block 610. Note that this method can be implemented as a computer program embodied on a computer readable medium wherein each block is represents one or more code segments of the computer program. The length of the frame will depend on a transmission time rather than the number of symbols or bits in the frame. In addition, the length of the frame can be variable, based on the successful receipt of the channel symbols or bits by the receiver, based on feedback from the receiver, or some other estimation technique. Note that the transmission medium can be a cellular network, a wireless network, an ultra-wide bandwidth (UMB) wireless network or an indoor wireless network and can use any multiplexing scheme, such as TDMA, CDMA or OFDM, etc.

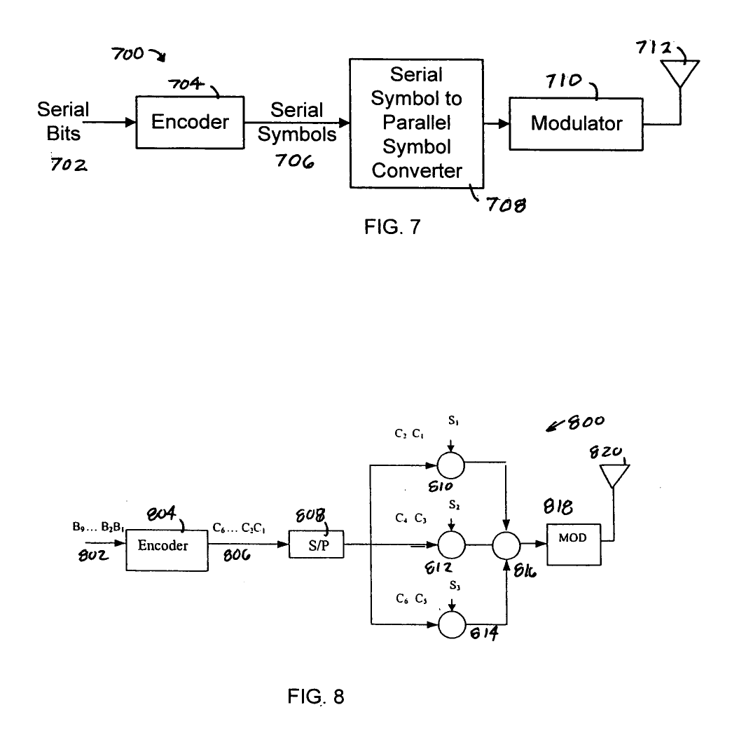

Referring now to FIG. 7, a block diagram of a transmitter 700 is accordance with one embodiment of the present invention is shown. The transmitter 700 includes an encoder 704, a serial to parallel symbol converter 708 communicably coupled to the encoder 704, a modulator 710 communicably coupled to the serial to parallel symbol converter 708, and one or more antennas 712 communicably coupled to the modulator 710. The encoder 704 produces a set of serial symbols 706 that represent the information to be transmitted during the frame from a set of serial bits 702. The serial to parallel symbol converter 708 produces one or more sets of parallel channel symbols from the set of serial symbols 706. The length of the frame will depend on a transmission time rather than the number of symbols or bits in the frame. In addition, the length of the frame can be variable, based on the successful receipt of the channel symbols or bits by the receiver, based on feedback from the receiver, or some other estimation technique. Note that the transmitter 700 can be configured to work in various transmission mediums, such as a cellular network, a wireless network, an ultra-wide bandwidth (UMB) wireless network or an indoor wireless network and can use any multiplexing scheme, such as TDMA, CDMA or OFDM, etc.

Now referring to FIG. 8, a block diagram of a transmitter 800 is accordance with another embodiment of the present invention is shown. The transmitter 800 includes an encoder 804, a serial to parallel symbol converter 808 communicably coupled to the encoder 804, one or more signature encoders 810, 812 and 814 communicably coupled to the serial to parallel symbol converter 808, a multiplexer 816 communicably coupled to the signature encoders 810, 812 and 814, a modulator 818 communicably coupled to the multiplexer 816, and one or more antennas 820 communicably coupled to the modulator 818. The encoder 804 produces a set of serial symbols 806 (C₁, C₂, . . . , C₆) that represent the information to be transmitted during the frame from a set of serial bits 802 (B₁, B₂, . . . , B₉). The serial to parallel symbol converter 808 produces one or more sets of parallel channel symbols (C₁ C₂, C₃ C₄, C₅ C₆) from the set of serial symbols 806 (C₁, C₂, . . . , C₆). As shown, signature encoder 810 encodes symbols C₁ C₂ with signature S₁, signature encoder 812 encodes symbols C₃ C₄ with signature S₂, and signature encoder 814 encodes symbols C₅ C₆ with signature S₃. The length of the frame will depend on a transmission time rather than the number of symbols or bits in the frame. In addition, the length of the frame can be variable, based on the successful receipt of the channel symbols or bits by the receiver, based on feedback from the receiver, or some other estimation technique. Note that the transmitter 800 can be configured to work in various transmission mediums, such as a cellular network, a wireless network, an ultra-wide bandwidth (UMB) wireless network or an indoor wireless network and can use any multiplexing scheme, such as TDMA, CDMA or OFDM, etc.

To provide integrated voice and data communications over cellular networks, several access strategies have been proposed for multi-rate DS/CDMA systems. One of them is multi-code access strategy. In the multi-code access strategy, all users are decomposed into multiple low rate users and their information bits are multiplexed onto multiple low rate signature waveforms by using BPSK or any other type of modulation scheme such as QPSK. After that each of the effective low rate user transmits its information symbols serially. Thus under the multi-code access strategy, transmitted bits do not extend longer than one bit duration.

To prevent errors from clustering in decoder bit streams, cellular systems introduce interleaving. An interleaver systematically scrambles (permutes) the order of bits generated by a channel coder. Receivers perform the inverse permutation in order to return the bits to the sequence in which they leave the encoder. While it has generally been understood that interleaving is not the most efficient of precoding strategies, the literature has offered quite a few alternatives. For example, space response precoding has been proposed as an alternative to interleaving. With spread response preceding, the faded channel as seen by the coded data stream was effectively transformed into a simple additive white Gaussian noise channel. Precoding was used on the coded data stream to spread the transmission of each symbol over a large number of time samples. As a consequence of such spreading, the performance of communication systems would be dictated by the average characteristics of the channel over time. In the spread response preceding, symbols of a user are linearly combined by employing an orthonormal transformation on the symbols. These techniques are typically restricted to single-user channels or equivalently, multiuser systems employing frequency division multiplexing. For CDMA systems, signature sequences that are significantly longer than the interval between symbols can be used. Using this approach, the transmission of each symbol of each user is, in effect, spread over a wide temporal and spectral extent, which is efficiently exploited to combat the effects of fading. Although CDMA systems are considered, however, very special types of signatures are used among users. Moreover, under this scheme, bits are transmitted in serial and as a result, frame duration could be significantly longer than that in the conventional system. In short, the only objective is to treat fading as a diversity in a wireless channel.

Transmission of linearly precoded symbols is a way to transmit symbols in parallel. The present invention (parallel CDMA system) can be viewed as a linearly precoded system where the linear transformation matrix which is applied to a block of symbols of a user, consists of long spreading sequences of those symbols. The duration of spreading sequences is the same as the block duration and they are not necessarily to be orthogonal. The present invention (parallel CDMA system) has enormous potential to be the one step solution for wireless communication channel for the following reasons. In a time varying channel, where the feedback from the receiver to the transmitter about the channel is not feasible, the present invention (parallel CDMA system) treats all symbols of a user in a frame uniformly by providing them the bad and good conditions of the channel in both time and frequency evenly. Thus it eliminates the use of interleaver in the system while providing the same throughput (frame/sec) as that provided by the conventional system. Moreover, in the present invention (parallel CDMA system), the receiver may come to all bits' decisions even before receiving the entire frame. In such cases, the transmitter may go into sleep mode until the next transmission time, or the transmitter may start transmitting the next available frame in the queue. This decreases the interference of the system and/or increases the system throughput. Using this unique property of the parallel bit transmission, the present invention introduces the soft frame length concept for wireless systems where the length of a frame depends on how long the frame is being transmitted rather than the number of bits in a frame. Besides the above, many properties, such as high diversity gain by space time code, feasibility of distributed power control algorithms, simplification of channel estimation process, easy implementation of non-coherent detection, robustness to multipath fading, interference suppression capability etc. are identified to be inherent to the present invention (parallel CDMA system). In a slowly varying channel, where the feedback between transmitters and the receivers are feasible, the joint optimum transmitter-receiver structures of the conventional CDMA and the OFDM systems can be designed through constraining the joint transmitter-receiver optimization problem of the proposed system. Thus, the present invention (parallel CDMA system) can be implemented in a conventional CDMA system or the OFDM system by the proper choice of signatures.

### Implementation of the Present Invention in a CDMA System

The implementation of the present invention is amenable to analytic solution for future generation wireless systems. These results allow more unified approaches to the study of optimal radio resource allocation in the present invention (parallel CDMA system) under various spatially/temporally volatile environments. The parallel CDMA system of the present invention is superior to the conventional CDMA system in terms of performance. Here, the assumption is that the channel can be perfectly estimated by the receiver.

In the CDMA system model, where many users are transmitting signals to one receiver, each bit results in the baseband transmission of a sequence of pulses, or chips, p[t], with each pulse having a duration of one chip period T_{c}. These pulses are sent over an additive white Gaussian noise channel in which the noise n(t) has power spectral density σ². The bit transmission time in the conventional CDMA system is T and thus the processing gain is L=T/T_{c}. There are K users in the system and user k employs power Pₖ to transmit its ith bit bₖ⁽ⁱ⁾ε{−1,1}.

The notation X^{T} is used in this work as the transpose of the matrix X and X^{H} denotes the hermitian of the matrix X. The present invention (parallel CDMA system) is modeled by using vector notations. Bits of a user are transmitted in a frame of length F. To model the proposed system, it is assumed that each frame consists of V sub-frames, where each sub-frame consists of ν=(F/V) bits. Using the present invention, a user simultaneously transmits all bits of B sub-frames, where B≦V. Thus each information bit of B sub-frames will be spread over the duration of B sub-frames which is βT where β=Bν. Without loss of generality, the first B sub-frames will be considered out of total V sub-frames. The received signal in the proposed system will be processed by the chip matched filter.

The carrier frequency is f_{c} Hz which yields the wavelength of the signal as λ=3×10⁸/f_{c} m and user k is moving at νₖ m/s. The popular rule of thumb for modern digital communications is to define the coherence time as Δₖ=(0.423λ)/νₖ. For the sake of simplicity, it is assumed that the time over which the bits are spread i.e., βT is an integer multiple of the coherence time Δₖ, i.e., βT/Δₖ=ηₖ is a positive integer. In the other words, the number of independent fades over β bits is an integer which is a standard assumption in cellular systems. In practice, βL may or may not be divisible by ηₖ. Since the processing gain L is large, βL will be quite large that allows βL/ηₖ=ζₖ to be modeled as a positive integer. Therefore, the channel coefficients of user k are the same over ζₖ chips and it varies independently after then.

Let aₖ^{(m,i)} be the mth complex spreading sequence used in the bit bₖ⁽ⁱ⁾; where m=1, . . . , βL and i=1, . . . , β. These spreading sequences are aₖ^{(m,i)} normalized such that Σₘ₌₁^{βL}|aₖ^{(m,i)}|²=1. Using O(n) to denote a zero row vector of size n, the description of the spreading sequences will be simplified by defining the βL×1 vector as

sₖ^{(j,i)}=[O((j−1)ζₖ),aₖ^{(j,i)},O((η−j)ζₖ)]^{T} j=1, . . . , ηₖ (1)

where aₖ^{(j,i)}=[aₖ^{(j′+1,i)}, . . . , aₖ^{(j′+ζ}^{ₖ}^{,i)}┘ and j′=(j−1)ζₖ. Using sₖ^{(j,i)}, define sₖ⁽ⁱ⁾=[sₖ^{(1,i)}, . . . , sₖ^{(η}^{ₖ}^{,i)}┘ which is an βL×ηₖ matrix. Denoting 1(m) as a row vector of size m whose all elements are 1, the complex channel coefficients of user k at the jth subinterval (which is [(j−1)Δₖ, jΔₖ]) is used to define Cₖ^{(j)}=cₖ^{(j)}×1(ηₖ). Defining Cₖ=[Cₖ⁽¹⁾, . . . , Cₖ^{(η}^{ₖ}⁾]^{T} and then using it with signature matrix sₖ⁽ⁱ⁾, the contribution of bit bₖ⁽ⁱ⁾ to the received signal vector at the output of chip matched filter can be written as rₖ⁽ⁱ⁾=\sqrt{Pₖ}bₖ⁽ⁱ⁾sₖ⁽ⁱ⁾Cₖ which yields the total received signal vector at the end of B sub-frame or β bits as

$$r = {\sum }_{k = 1}^{K} {\sum }_{i = 1}^{β} {r}_{k}^{( i )} + N \qquad ( 2 )$$

where N is a βL×1 white Gaussian Noise vector with mean zero and co-variance σ²TcI_{βL}. Without loss of generality, in the present invention (parallel CDMA system), bit 1 of user 1 (i.e., b₁⁽¹⁾) is the bit of interest. Thus, in equation (2), the desired portion of the received signal is

R_{d}=\sqrt{P₁}b₁⁽¹⁾s₁⁽¹⁾C₁ (3)

The self-interference and multiple access interference portions are

$${R}_{s} = {\sum }_{i = 2}^{β} {r}_{1}^{( i )} = {\sum }_{i = 2}^{β} \sqrt{{P}_{1}} {b}_{1}^{( i )} {s}_{1}^{( i )} {C}_{1} \\ {R}_{m} = {\sum }_{k = 2}^{K} {\sum }_{i = 1}^{β} {r}_{k}^{( i )} = {\sum }_{k = 2}^{K} {\sum }_{i = 1}^{β} \sqrt{{P}_{k}} {b}_{k}^{( i )} {s}_{k}^{( i )} {C}_{k} \qquad ( 4 )$$

respectively.

### Receiver Structure

In the receiver structure, the matched filter for bit b₁⁽¹⁾ is

$$Φ = \frac{{s}_{( 1 )}^{( 1 )} {C}_{1}}{‖ {s}_{( 1 )}^{( 1 )} {C}_{1} ‖} \qquad ( 5 )$$

After applying the matched filter Φ to equation (2), the decision statistics for bit b₁⁽¹⁾ is obtained as

r=Φ^{H}r=R_{d}+Rₛ+Rₘ+N (6)

where N is a Gaussian random variable with mean zero and variance σ²Tc. The term

$${R}_{d} = {Φ}^{H} {R}_{d} = \sqrt{{P}_{1}} {b}_{1}^{( 1 )} {Φ}^{H} {s}_{1}^{( 1 )} {C}_{1} = \sqrt{{P}_{1}} {b}_{1}^{( 1 )} \sqrt{{\sum }_{i = 1}^{{n}_{1}} {\vert {c}_{1}^{( i )} \vert}^{2} / {η}_{1}} \qquad ( 7 )$$

denotes the desired part of the information signal at the output of the matched filter which is always real and

$${R}_{d} = {Φ}^{H} {R}_{s} = {\sum }_{i = 2}^{β} \sqrt{{P}_{1}} {b}_{1}^{( 1 )} {Φ}^{H} {s}_{1}^{( 1 )} {C}_{1} \\ {R}_{m} = {Φ}^{H} {R}_{m} = {\sum }_{k = 2}^{K} {\sum }_{i = 1}^{β} \sqrt{{P}_{k}} {b}_{k}^{( i )} {Φ}^{H} {s}_{k}^{( i )} {C}_{k} \qquad ( 8 )$$

are the self-interference and the multiple access interference respectively. Finally, the sign of the real part of the decision statistics of equation (6) will be taken as the estimate of the information bit b₁⁽¹⁾.

### Performance Analysis

The performance of the present invention (parallel CDMA system) is analyzed and compared to that of the conventional CDMA system. Both SIR and BER are used as the performance measures. In the analysis, spreading sequences of a user are assumed as uncorrelated equally likely sequences. It is also assumed that the channel coefficients {cₖ^{(j)}} are independent complex Gaussian random variables with

$$E [ {c}_{k}^{( i )} ] = 0 and E [ {\vert {c}_{k}^{( i )} \vert}^{2} ] = 2 {σ}_{k}^{2}$$

and the channel coefficients of two different users are independent. In order to analyze the bit error rate (BER) of the present invention (parallel CDMA system), the interferences will be modeled as a Gaussian random variable.

The SIR of bit b₁⁽¹⁾ is defined as the ratio of the instantaneous received energy of bit b₁⁽¹⁾ to the sum of interference and noise variances. To derive the SIR of bit b₁⁽¹⁾, the following lemmas are required.

Lemma 1: In the present invention (parallel CDMA system), the instantaneous energy of bit b₁⁽¹⁾ at the output of the matched filter is

$${P}_{in} = {R}_{d}^{2} = {P}_{1} {\sum }_{i = 1}^{{n}_{1}} {\vert {c}_{1}^{( i )} \vert}^{2} / {η}_{1} .$$

Lemma 2: In the present invention (parallel CDMA system), when channel coefficients of users {cₖ^{(j)}} are independent complex Gaussian random variables with

$$E [ {c}_{k}^{( i )} ] = 0 and E [ {\vert {c}_{k}^{( i )} \vert}^{2} ] = 2 {σ}_{k}^{2} ,$$

the second moment of the multiple access interference at the output of the matched filter

$$is {\overline{R}}_{m}^{2} = E [ {\vert {R}_{m} \vert}^{2} ] = {\sum }_{k = 2}^{K} {P}_{k} \frac{2 {σ}_{k}^{2}}{L} .$$

Since the self-interference experiences the same channel coefficients as the desired bit does, analyzing the second moment of the self-interference is significantly different from analyzing the second moment of multiple access interference. The self interference is characterized by proving the following two lemmas.

Lemma 3: In the present invention (parallel CDMA system), when channel coefficients of user 1, {c₁⁽ⁱ⁾} are independent complex Gaussian random variables with

$$E ⌊ {c}_{1}^{( i )} ⌋ = 0 and E [ {\vert {c}_{1}^{( i )} \vert}^{2} ] = 2 {σ}_{1}^{2} ,$$

the second moment of the self-interference at the output of the matched filter is bounded as

$$\frac{2 {P}_{1} ( β - 1 ) {σ}_{1}^{2}}{β L} \leq {\overline{R}}_{s}^{2} = E [ {\vert {R}_{s} \vert}^{2} ] \leq \frac{2 {P}_{1} ( β - 1 ) {σ}_{1}^{2}}{β L} {\sum }_{i = 1}^{{η}_{1}} 1 / i .$$

Lemma 4: In the present invention (parallel CDMA system), when channel coefficients of user 1, {c₁⁽ⁱ⁾} are independent complex Gaussian random variables with

$$E ⌊ {c}_{1}^{( i )} ⌋ = 0 and E [ {\vert {c}_{1}^{( i )} \vert}^{2} ] = 2 {σ}_{1}^{2} ,$$

as the diversity order η₁→∞, the conditional second moment of the self interference at the output of the matched filter given {c₁⁽ⁱ⁾} approaches

$${lim}_{{η}_{1} \to ∞} {\overline{R}}_{s}^{2} = \frac{4 {P}_{1} ( β - 1 ) {σ}_{1}^{2}}{β L} w . p .1$$

Lemma 3 implies that the self interference in the present invention (parallel CDMA system) is more than a multiple access interference. However, as the number of bits of the conventional system over which a bit in the parallel system will be spread approaches to infinity (i.e., β→∞) and the diversity order η₁→∞, the self interference in the parallel system will be equivalent to two multiple access interference; see Lemma 4. In a parallel CDMA system with random signatures, the effect of the self interference could be an obstacle in order to achieve very high signal-to-interference ratio. As a result, orthogonal codes can be used to process the bits of a user in the parallel system when very low bit error rate needs to be achieved. This could be done similar to the downlink of the existing IS-95 where orthogonal spreading sequences are derived by using random spreading with the orthogonal Walsh Codes. In order to eliminate self-interference completely all β codes of a user must be orthogonal within the coherence time. Thus to eliminate the self interference β must satisfy

$$β < L [ \frac{{Δ}_{c}}{T} ] .$$

Since fades in wireless signals last for several bit intervals, maintaining orthogonality among all parallel codes of a user are feasible.

Since the variance of noise N at the output of matched filter is σ²Tc, Lemmas 1-4 yield following theorem.

Theorem 1: In the present invention (parallel CDMA system) when channel coefficients {cₖ^{(j)}} are independent complex Gaussian random variables with

$$E ⌊ {c}_{k}^{( j )} ⌋ = 0 and E [ {\vert {c}_{k}^{( j )} \vert}^{2} ] = 2 {σ}_{k}^{2} ,$$

the SIR of bit b₁⁽¹⁾ at the output of the matched filter which is

$${Γ}_{1}^{( 1 )} = \frac{{P}_{in}}{{\overline{R}}_{s}^{2} + {\overline{R}}_{m}^{2} + {σ}^{2} {T}_{c}}$$

satisfies

$$\frac{{P}_{1} {\sum }_{i = 1}^{{η}_{1}} {\vert {c}_{1}^{( i )} \vert}^{2} / {η}_{1}}{\frac{2 {P}_{1} ( β - 1 ) {σ}_{1}^{2}}{β L} {\sum }_{i = 1}^{{η}_{1}} 1 / i + \frac{{\sum }_{k = 2}^{K} 2 {P}_{k} {σ}_{k}^{2}}{L} + {σ}^{2} {T}_{c}} \leq {Γ}_{1}^{( 1 )} \leq \frac{{P}_{1} {\sum }_{i = 1}^{{η}_{1}} {\vert {c}_{1}^{( i )} \vert}^{2} / {η}_{1}}{\frac{2 {P}_{1} ( β - 1 ) {σ}_{1}^{2}}{β L} {\sum }_{i = 1}^{{η}_{1}} 1 / i + \frac{{\sum }_{k = 2}^{K} 2 {P}_{k} {σ}_{k}^{2}}{L} + {σ}^{2} {T}_{c}} as {η}_{1} \to ∞ .$$

Performing a similar analysis, the SIR of bit b₁⁽¹⁾ will be obtained in the conventional system as

$${Γ}_{1 , c}^{( c )} = \frac{{P}_{1} {\vert {c}_{1}^{( 1 )} \vert}^{2}}{{\sum }_{k = 2}^{K} 2 {P}_{k} {σ}_{k}^{2} / L + {σ}^{2} {T}_{c}} \qquad ( 9 )$$

Comparing Theorem 1 with equation (9), one can see that the present invention (parallel CDMA system) suffers from more interference than the conventional CDMA system due to the self-interference. Lemma 4 suggests that the effect of the self-interference can be viewed as two additional interfering users in the system. In practice, the total number of interfering users is large. Thus the self-interference would be negligible compared to the multiple access interference. In addition, this self-interference can be easily eliminated completely by using orthogonal codes for all bits of user 1. Thus the crucial factor that will dictate the performance ascendancy of the proposed system over the conventional system are the received energies of bit b₁⁽¹⁾ in both systems. In this regard, the following theorem would be decisive.

Theorem 2: When channel coefficients of user 1 {c₁⁽ⁱ⁾} are independent and identically distributed complex Gaussian random variables, the received energy in the parallel system is higher than that in the conventional CDMA system with probability

$$1 - \frac{1}{{( 1 + \frac{1}{{η}_{1} - 1} )}^{{η}_{1} - 1}}$$

where η₁ is the diversity order in the present invention (parallel CDMA system).

From Theorem 2 the following useful corollary is obtained.

Corollary 1: When diversity order in the parallel system η₁≧2, the probability that the received signal energy is higher in the proposed system than that in the conventional system is greater than or equal to ½. As η₁→∞,

$${lim}_{{η}_{1} \to ∞} Pr ( {\sum }_{i = 1}^{{η}_{1}} {\vert {c}_{1}^{( i )} \vert}^{2} / {η}_{1} > {\vert {c}_{1}^{( 1 )} \vert}^{2} ) = 1 - {lim}_{{η}_{1} \to ∞} \frac{1}{{( 1 + \frac{1}{{η}_{1} - 1} )}^{{η}_{1} - 1}} = 1 - {ⅇ}^{- 1} \approx 0.63$$

The above corollary suggests that it is more likely that the received energy is higher in the parallel system than that in the conventional system. The probability that the received energy in the present invention (parallel CDMA system) is higher than that in the conventional CDMA system is an increasing function of the diversity order η₁ and as η₁→∞, it approaches 1−e⁻¹. Based on the foregoing, user 1 experiences almost similar average interference power at the output of the matched filter in both the parallel and conventional systems, however, it is more likely that the parallel system will provide higher received energy at the matched filter output than the conventional system. As a consequence, SIR is expected to be higher in the parallel system than in the conventional system. The closed form solution for the BER equation in the parallel system is

$${P}_{b} = {[ \frac{1}{2} ( 1 - μ ) ]}^{{η}_{1}} {\sum }_{k = 0}^{{η}_{1} - 1} {( {η}_{1} - 1 + k ) [ \frac{1}{2} ( 1 + μ ) ]}^{k} \qquad ( 10 )$$

where, by definition

$$\begin{matrix}μ = \sqrt{\frac{\overline{γ}}{1 + \overline{γ}}} and & ( 11 ) \\ \overline{γ} = E [ {Γ}_{1}^{( 1 )} ] / {η}_{1} = \frac{{P}_{1} 2 {σ}_{1}^{2} / {η}_{1}}{{\overline{R}}_{s}^{2} + {\overline{R}}_{m}^{2} + {σ}^{2} {T}_{c}} & ( 12 )\end{matrix}$$

where \overline{γ} denotes the average SIR per subinterval.

The derivation of the BER equation (10) of the present invention (parallel CDMA system) is the same as that of the RAKE receiver in a Rayleigh faded AWGN channel. The diversity gain obtained through the proposed parallel bit transmission technique is not equivalent to the diversity gain obtained through the RAKE receiver in a multi-path channel. Simply because, in the parallel system, one could select the diversity order by increasing β, however, the diversity order of the rake receiver (i.e., the number of paths) is provided by the multi-path channel. The diversity gain of the present invention (parallel CDMA system) will be increased if multiple transmit and received antennas are used. If the channel varies rapidly, the diversity gain given by the proposed and transmit space diversity techniques jointly can be achieved only by the proposed bit transmission technique at the cost of additional delay. However, the proposed technique is much more efficient in terms of cost and hardware complexity compared to the transmit space diversity. In the case when channels are varying over time, however different antennas have correlated fading, in that case, the transmit space diversity technique fails to yield any capacity gain, whereas, in this situation, the proposed technique has the potential of providing significant capacity improvement. At the other extreme situation, when channels are stationary over time, however different antennas have independent fading, the transmit spatial diversity will provide the capacity gain but the proposed diversity will not.

### Empirical Results

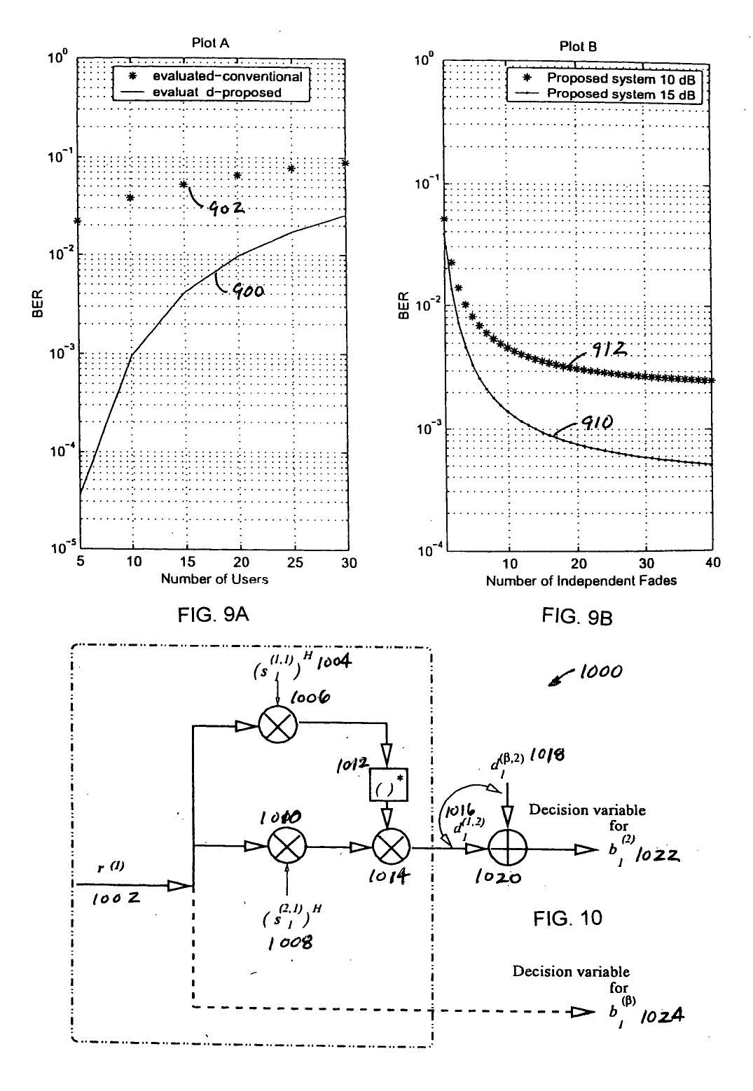

An empirical study of the present invention was performed to observe how the present invention (parallel CDMA system) performs against the conventional system. These empirical results are shown in FIGS. 9A and 9B. Here it is assumed that β=ηₖ that means, the coherence time of the channel was one bit duration. In each experiment the simulation results matched to the analytical results perfectly.

In Plot A (FIG. 9A), the evaluated BERs of the conventional CDMA system (plot 902) and the present invention (plot 900) (parallel CDMA system) are plotted against the number of users for SNR=15 dB and β=15. For β=15, the present invention (parallel CDMA system) is capable of yielding more than six times the capacity of the conventional system when the target BER=0.01. The present invention (parallel CDMA system) has also been implemented in a multipath environment.

In Plot B (FIG. 9B), the evaluated BER of the present invention (parallel system) is plotted as a function of β for K=10 and average received SNR=10 (plot 912) and 15 Db (plot 910). In both cases, the BER gain is almost negligible after 15 independent fades. This result is supported by the evaluated probability derived in Theorem 2, which is the probability that the received energy in the present invention (parallel CDMA system) is higher than that in the conventional CDMA system.

The wireless channels could be rapidly or slowly time varying depending on the system environment. Therefore, the implementation of the present invention (parallel CDMA system) will be different in different system environments. It is assumed that the channel is rapidly varying, the receiver could operate with or without channel estimates and however, any feedback from the receiver to the transmitter is not feasible. Then, the slowly varying channel is assumed where the receiver can perfectly estimate the channel coefficients and all sorts of feedback between the transmitter and receiver is possible. The previous discussion considers mainly the system scenario where many transmitters are transmitting to one receiver. However, the present invention is applicable to other possible system scenarios, such as “one transmitter to many receivers” and “many transmitters to many receivers”.

### Pilot Assisted Channel Estimation

On BPSK, detected coherently, it was assumed that noiseless estimates of the complex-valued channel parameters {cₖ^{(j)}} were used at the receiver. However, in practice, the parameters {cₖ^{(j)}} need to be estimated. In a time a varying channel, this estimation is feasible by using pilot symbols. Numerous works have been done for channel estimation using pilot symbols. In the conventional uplink CDMA system, pilot symbols are generally used to estimate the channel. The pilot and information symbols are generally placed alternately in the frame. The pilot symbols which are immediately before and after the information symbols are used to estimate the channel coefficients for the information symbols. However, the quality of the estimates heavily depends on how fast the channel is varying. Moreover, the pilot symbols which are far away from the information symbols do not provide any significant information about the channel of those information symbols. Since in the parallel system, the pilot symbol together with the information symbols will undergo the same channel conditions, the pilot symbol will carry the same information of all the channel states as the information symbols will. This will assist the system in coherent detection.

### Differentially Encoded Parallel CDMA System (Present Invention)

On BPSK, detected coherently, it was assumed that noiseless estimates of the complex-valued channel parameters {cₖ^{(j)}} were used at the receiver. Since the channel is time variant and suffers from interference, the parameter {cₖ^{(j)}} cannot be estimated perfectly. In fact, on some channels the time variations may be sufficiently fast to preclude the implementation of coherent detection. In such case, the present invention uses either DPSK signaling or non-coherently detected orthogonal signaling. It should be noted that when the symbols are transmitted in serial, at the receiver, the standard assumption is that the channel variations must be sufficiently slow so that the channel phase shifts {φₖ^{(j)}} do not change over two consecutive signaling intervals. Since in the proposed system DPSK symbols will be transmitted in parallel, the parallel system does not suffer from that assumption.

Referring now to FIG. 10, a demodulator 1000 of DPSK signals in accordance with the present invention is shown. The receiver structure of the DPSK signals is given in FIG. 10, which is similar to RAKE demodulation for DPSK signals in the conventional system. r^{(j)} 1002 denotes the output of the chip matched filter at the end of the jth sub-interval (which is [(j−1)Δ₁, jΔ₁]), b₁⁽¹⁾ is used as the reference symbol, d₁^{(j,i)} is the contribution of the jth subinterval to the decision variable of symbol b₁⁽ⁱ⁾ (1022 and 1024). r^{(j)} 1002 is multiplexed with (s₁^{(1,1)})^{H} 1004 at 1006 and (s₁^{(2,1)})^{H} 1008 at 1010. The output of 1010 is then multiplexed with the complex conjugate 1012 of the output of 1006 at 1014 to produce d₁^{(1,2)} 1016. d₁^{(1,2)} 1016 is added to d₁^{(β,2)} 1018 at 1020 to produce decision variable for b₁⁽²⁾ 1022. The BER analysis of the DPSK signals in the parallel system will be similar to the BER analysis of DPSK signals in the multipath conventional system. The difference in performance between DPSK and coherent PSK is approximately 3 dB. However, in practice, the coherent PSK needs to be implemented by estimating channel and the gain of the coherent PSK over DPSK would be less. Thus, a comparison of the performance of the DPSK signals with that of the pilot assisted coherent detection of PSK signals in present invention (parallel CDMA systems) is desirable.

### Power Control

The objective of power control is to find transmitter power levels for all users so that the sum of the transmitter power is minimized subject to the quality of service (QoS) requirements of users. In CDMA systems, QoS is defined in terms of the average signal-to-interference ratio (SIR). The power control problem is an eigenvalue problem of non-negative matrices and the solution is obtained through a matrix inversion. These power control algorithms are centralized and non-iterative. This is followed by the development of iterative and distributed algorithms that required only local measurements. These distributed power control algorithms assumed the channel as stationary until they converge to optimal power solutions. However, the wireless channel is rapidly time varying. As a result, these power control algorithms are not practical in most of the cases.

In practice, the frame length is considerably large. As a result, in the present invention (parallel CDMA system), all bits of a user undergo various channel conditions and get the average channel effect. Thus the channel of a user in the present invention (parallel CDMA system) will appear to be quasi-stationary. This fact is expected to make the distributed power control algorithms feasible in the parallel system and this conjecture must be verified.

In order to perform the work on the power control, the perfect measurements of deterministic quantities such as the SIR, received power, or interference will be assumed available in order to prove that the transmitter powers converge deterministically to an optimum power vector. In practice, however, these quantities cannot be estimated perfectly and deterministic convergence results are invalid when these deterministic variables are replaced with their random estimates. Consequently, the term stochastic power control is adopted for algorithms that use actual random measurements in parallel system to converge stochastically to the optimal transmitter power vector.

For conventional matched filter receivers, stochastic power control for matched filter receivers have been studied where each user aims for a target SIR using its matched filter output. However, each user is required to estimate its uplink channel gain to its assigned base station. In the present invention (parallel CDMA system), due to the effect of the time averaging of the channel, the uplink channel of a user could be estimated by its downlink channel. Stochastic measurements are used at each user's filter output to derive stochastic mean square convergence results for decorrelating receivers.

### Coding in Parallel CDMA System (Present Invention)

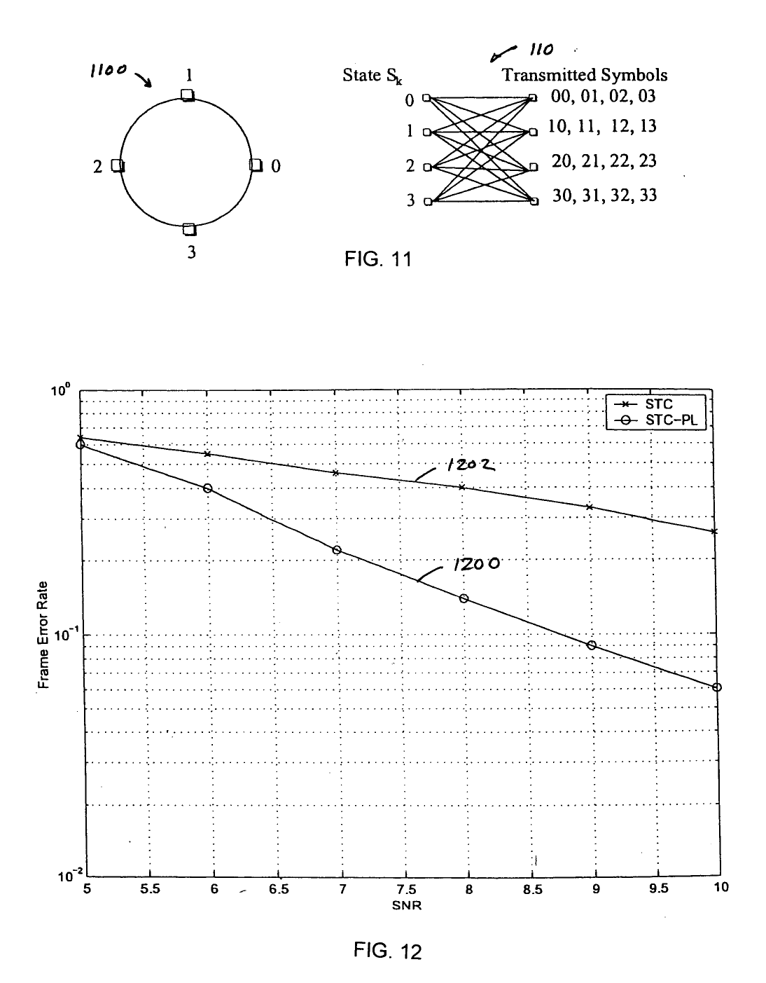

Now referring to FIG. 11, the 4PSK constellation points 1100 and the four-state, 4PSK space-time trellis codes 1102 in accordance with the present invention are shown. Coding techniques such as trellis-coded modulation, turbo codes, can be easily implemented in the parallel system where the parallel symbol transmission combats multiplicative fading effects while the coding handles additive interference and noise effects. The next generation wireless systems will use multiple antennas at the transmitter and at the receiver. These multiple antennas facilitate the use of space-time coding to support high data rate traffic. Space-time trellis codes incorporate jointly designed channel coding, modulation, transmit diversity and optional receiver diversity. Both the diversity gain and coding gain of the codes are determined by the minimum rank and the minimum determinant of the matrices, respectively. The space-time trellis codes provide the best tradeoff between data rate, diversity advantage and trellis complexity. As a further performance improvement, other codes such as turbo codes or convolutional codes can be used with the space-time codes. The space-time codes efficiently exploit the temporal diversity offered by the present invention (parallel CDMA system).

The implementation of the space time code in the present invention is somewhat different than that in the conventional system. The space time encoder sends symbols serially to the antennas and each of the antennas broadcasts symbols in parallel. When the signal will be received at the receiver, the parallel-to-serial operation will be performed before employing the space-time decoder which is essentially a soft Viterbi decoder. The space-time code is implemented in the following.

The number of transmitting antennas is two and each receiver is equipped with one antenna. User 1 spreads each symbol over the frame and its transmitted sequences are denoted by the antenna i as X_{i,1}⁽⁰⁾, . . . , X_{i,1}^{(β)} where i=1, 2. Note that in the conventional system symbols X_{1,1}⁽ⁿ⁾ and X_{2,1}⁽ⁿ⁾ are transmitted simultaneously. In the present invention (parallel system), symbols X_{1,1}⁽ⁿ⁾ and X_{2,1}⁽ⁿ⁾ will be coupled by processing them with the same spreading signatures s₁^{(m,1)}. The signature sequences which are transmitted during the mth subinterval (which is [(m−1)Δ₁, mΔ₁]) compose the signature vector s₁^{(m,1)} where m=1, . . . , η₁. At the end of the mth subinterval, the received signal vector at the output of the chip matched filter is

$${r}^{( m )} = {\sum }_{n = 1}^{β} ( {c}_{1 , 1}^{( m )} {X}_{1 , 1}^{( n )} + {c}_{2 , 1}^{( m )} {X}_{2 , 1}^{( n )} ) {s}_{k}^{( m , n )} + {n}^{( m )} m = 1 , … , {η}_{1} \qquad ( 13 )$$

where c_{l,1}^{(m)} denotes the complex channel gain of user 1 at the lth antenna where l=1, 2 during the mth subinterval. The term n^{(m)} denotes the additive noise which is assumed as Gaussian random vector resulted from the sum of the interference and the background noise. From equation (13), the nth transmitted symbol sequence is processed by applying [sₖ^{(m,n)}]^{H} on r^{(m)} as

$$\begin{matrix}{\overline{r}}^{( m , n )} = \frac{{c}_{1 , 1}^{( m )} {X}_{1 , 1}^{( n )} + {c}_{2 , 1}^{( m )} {X}_{2 , 1}^{( n )}}{{η}_{1}} + \\ {\sum }_{p \neq n}^{β} {( {c}_{1 , 1}^{( m )} {X}_{1 , 1}^{( p )} + {c}_{2 , 1}^{( m )} {X}_{2 , 1}^{( p )} ) [ {s}_{1}^{( m , n )} ]}^{H} {s}_{1}^{( m , p )} + {[ {s}_{1}^{( m , n )} ]}^{H} {n}^{( m )}\end{matrix} \qquad ( 14 )$$

where n=1, . . . , β and m=1, . . . , η₁. Viterbi algorithm based maximum likelihood sequence estimator will be applied to equation (14) to decode the transmitted symbols. For the nth trellis transition, there are two estimated transmit symbols, namely \hat{X}_{1,1}⁽ⁿ⁾ and \hat{X}_{2,1}⁽ⁿ⁾, for which the branch metric M⁽ⁿ⁾ is given by

$${M}^{( n )} = {\sum }_{m = 1}^{{η}_{1}} {\vert {\overline{r}}^{( m , n )} - ( {c}_{1 , 1}^{( m )} {\hat{X}}_{1 , 1}^{( n )} + {c}_{2 , 1}^{( m )} {\hat{X}}_{2 , 1}^{( n )} ) / {η}_{1} \vert}^{2} \qquad ( 15 )$$

The above branch metric for the nth trellis transition appears similar to that for the nth trellis transition of the conventional system with η₁ receiving antennas. Thus, the diversity gain provided by the space-time code in the present invention (parallel CDMA system) is rη₁m, where r is the minimum rank of the code difference matrix B(c,e), m is the number of receiving antennas and η₁ is the number of independent fades within the frame or sub-frame. When the channels are stationary at the both antennas (i.e., η₁=1), the diversity gain of the space time code in the present invention (parallel system) will be the same as that in the conventional system when the channel gains are independent at the two antennas but stationary over the frame. The coding gain of the space-time code in the present invention (parallel CDMA system) is determined by the determinant criterion of the conventional system for η₁=1. Thus, the codes which are designed for the quasi-stationary conventional systems are efficient codes for the present invention (parallel CDMA system) to support high rate users.

Referring now to FIG. 12, a graph comparing the performance of the present invention to a prior art system is shown. The performance of the space-time code in the present invention (parallel CDMA system) is demonstrated using the simplest 4-state, 4-level Phase Shift Keying (4PSK) space-time trellis code which has been developed for two transmit antenna system. A single user symbol synchronous CDMA system is modeled where carrier frequency f_{c}=2 GHz. The number of receiving antenna was one. The frame length was 20 ms and the number of QPSK symbols in a frame was 64. The processing gain of the system=128. The number of users was one who was moving at 60 miles/hour. The codes were designed such a way that the user did not suffer from the self-interference. The coherence time of the channel=2.4 ms i.e. the channel was stationary over 8 QPSK symbols. The experimental results indicated that the space-time code of FIG. 11 performed significantly better in the present invention (parallel CDMA system) (plot 1200), which is expected from the analysis, than in a conventional CDMA system (plot 1202).

### Signal Processing Aided Frame Transmission Scheme

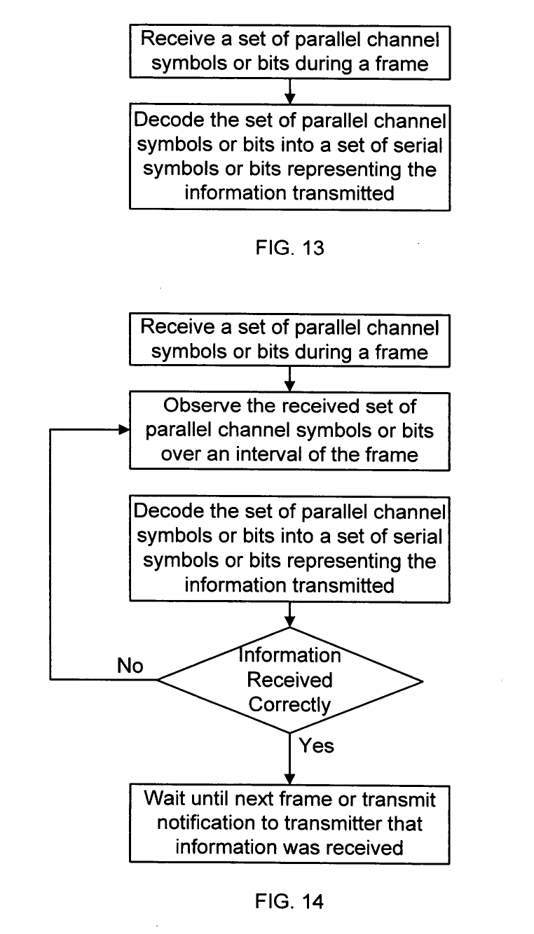

Now referring to FIG. 13, a flowchart illustrating a method 1300 of receiving information over a transmission medium in accordance with one embodiment of the present invention is shown. More specifically, a set of parallel channel symbols or bits are received during a frame in block 1302 and the set of parallel channel symbols or bits are decoded into a set of serial symbols or bits representing the information transmitted in block 1304. The length of the frame will depend on a transmission time rather than the number of symbols or bits in the frame. In addition, the length of the frame can be variable, based on the successful receipt of the channel symbols or bits by the receiver, based on feedback from the receiver, or some other estimation technique. Note that the transmission medium can be a cellular network, a wireless network, an ultra-wide bandwidth (UMB) wireless network or an indoor wireless network and can use any multiplexing scheme, such as TDMA, CDMA or OFDM, etc.

Referring now to FIG. 14, a flowchart illustrating a method 1400 of receiving information over a transmission medium in accordance with another embodiment of the present invention is shown. More specifically, a set of parallel channel symbols or bits are received during a frame in block 1402 and the received set of parallel channel symbols or bits are observed over an interval of the frame in block 1404. The received set of parallel channel symbols or bits are then decoded into a set of serial symbols or bits representing the information transmitted in block 1406. If the information transmitted was received correctly, as determined in decision block 1408, the receiver waits or sleeps until the next frame or transmits a notification or acknowledgement to the transmitter indicating the information was received in block 1410. If, however, the information was not correctly received, as determined in decision block 1408, the process loops back to block 1404 where the received set of parallel channel symbols are observed over another interval of the frame and process repeats as previously described. The length of the frame will depend on a transmission time rather than the number of symbols or bits in the frame. In addition, the length of the frame can be variable, based on the successful receipt of the channel symbols or bits by the receiver, based on feedback from the receiver, or some other estimation technique. Note that the transmission medium can be a cellular network, a wireless network, an ultra-wide bandwidth (UMB) wireless network or an indoor wireless network and can use any multiplexing scheme, such as TDMA, CDMA or OFDM, etc.

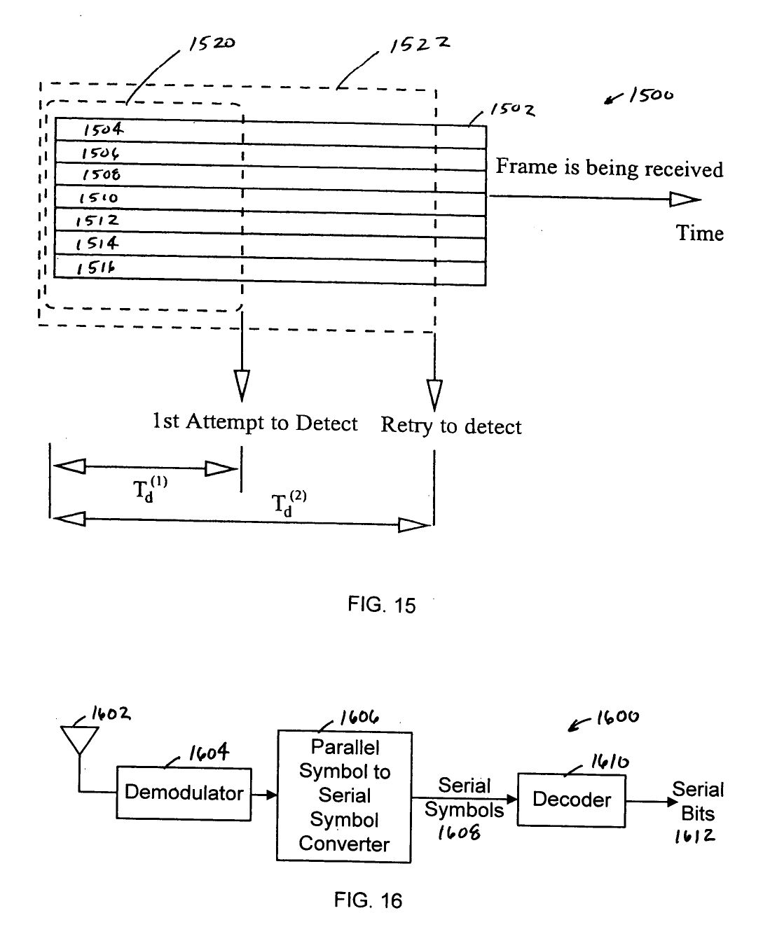

Now referring to FIG. 15, the early frame detection concept 1500 for a receiver in accordance with the present invention is shown. When all the symbols or bits (1504, 1506, 1508, 1510, 1512, 1514 and 1516) of a frame 1502 are transmitted in parallel, the receiver may come to all bits' decisions even before receiving the entire frame. T_{d}⁽ⁱ⁾ denotes the time when the receiver makes the ith attempt to detect the frame. If the frame is detected correct, the transmitter may go into sleep mode until the next transmission time, or the transmitter may start transmitting the next available frame in the queue. This will decrease the interference of the system and save the battery life or/and increase the throughput of the system. As shown, the first interval for detection is T_{d}⁽¹⁾ 1520 and the second interval for detection is T_{d}⁽²⁾ 1522.

An algorithm that will perform the early frame decision is given as follows. Here it is assumed that the information bits are first processed with CRC encoder and then the resultant code will be sent through a channel encoder such as convolutional encoder or space-time encoder, etc.

Step 1: Set n=1

Step 2: Observe the received signal over the interval └0,T_{d}⁽ⁿ⁾┘

Step 3: Decode the information bits along with cyclic redundancy check (CRC) bits from the received signal

Step 4: Detect the error by using CRC check

Step 4a: If error is detected, then set n=n+1 and Go To Step 2, otherwise, STOP

The execution time of the above algorithm will be mainly governed by the processing speed of channel decoder at Step 3. The Xilinx Soft Viterbi Decoder can operate at 200 MHz and achieve 18 Mbps; this information is obtained from http://www.xilinx.com. The latency will depend on the various system parameters such as constraint length, traceback length, frame length etc. The huge success of the VLSI and signal processing technologies in the last decade makes it apparent that the processing speed of channel decoder at Step 3 will not be a hindrance to the implementation of the proposed algorithm.

In the early frame decision technique, if a frame is detected in error, in the next frame detection, the previously transmitted information of that frame will be processed with the newly received frame information. To implement the early frame decision technique, the receiver should choose T_{d}⁽¹⁾, T_{d}⁽²⁾, . . . efficiently in order to avoid unnecessary signal processing tasks. Before making the first attempt to detect the frame, it is necessary to make sure that the instantaneous QoS (such as SIR or received power) of the desired user is sufficient. Therefore, a quick method of estimating the instantaneous QoS of a user in the present invention (parallel system) can be used. The nature of parallel bit transmission can be exploited to estimate SIR easily. In the present invention (parallel system), the sum of the signal, interference and noise powers can be estimated by first squaring and then averaging the output of the matched filters of all the bits. As a result, the estimate of the desired signal power or the estimate of the sum of interference and noise powers can be used to estimate the SIR. Estimation of the desired signal power can be done by using channel estimates.

A system with early frame decision can be viewed as a system where the frame length adapts to channel situations. The present invention provides this “soft frame length” concept for wireless systems where the length of a frame depends on how long the frame is being transmitted rather than the number of bits in a frame.

When the desired user will achieve the target instantaneous QoS, the receiver will send a signal to the transmitter indicating that it has started processing the frame. This signal is referred as the frame detection signal (or FDS). The FDS would be used in the receiver-transmitter link like the way power control bit are being used in IS-95. If the frame detection can be done very quickly, there will be no need for FDS. If the transmitter is a real-time user such as voice who can not tolerate delay, will not receive the FDS and keep on transmitting until it receives the acknowledgment. In the case of data users who can tolerate delay, the next frame will be transmitted immediately after the FDS signal will be received. If a not acknowledgment (NAK) signal arrives at the transmitter for previously transmitted frame, then it will be re-transmitted after FDS will arrive for the current frame. If the FDS provides false alarm, the receiver will increase threshold of the instantaneous QoS of the frame by a dB. When the frame will be detected correctly, the QoS will be set to the initial threshold value. If NAK arrives multiple times for the same frame then similar to the delay intolerant user, the transmitter may transmit the same frame until it arrives correctly in order to simplify ACK and NAK process. After then it will transmit the frame which will be currently requested by the receiver.

To select the proper threshold values of QoS, an analysis of the instantaneous QoS estimation error must be performed. Since the estimation can not be perfect, the threshold of the instantaneous QoS will be higher than it is required and how much higher will depend on the reliability of the estimation. The value of Δ will be in 0.5, 1.5, . . . dB. Higher value of Δ will be chosen when the estimation error of instantaneous QoS is high. The effect of instantaneous QoS estimation error and Δ in the performance of the proposed transmission protocols must be investigated. The study of early frame detection will be performed in conjunction with power control. The goal of the power control will be to meet the SIR requirement of a user within a fixed length frame.

For the delay tolerant users, the proposed early frame decision technique will also be studied against ARQ methods proposed for incremental redundancy transmission in wireless systems (Source: Lucent Technologies, Agenda Item:AH24, HSDPA). In incremental redundancy a code block is coded into several encoded blocks. On receiving a NAK, transmitter sends the redundant information by transmitting additional encoded sub-blocks one at a time and for ACK, it continues with the transmission of new code block.

Referring now to FIG. 16, a block diagram of a receiver 1600 in accordance with the present invention is shown. The receiver 1600 includes one or more antennas 1602, a demodulator 1604 communicably coupled to the one or more antennas 1602, a parallel to serial symbol converter 1606 communicably coupled to the demodulator 1604 and a decoder 1610 communicably coupled to the parallel to serial symbol converter 1606. The parallel to serial symbol converter 1606 produces a set of serial symbols 1608 from the received set of parallel symbols. The decoder 1610 produces a set of serial bits 1612 representing the information transmitted during a frame from the set of serial symbols 1608. In one embodiment of the present invention, the decoder 1610 (a) observes the received serial symbols over an interval of the frame, (b) decodes the serial symbols into a set of serial bits representing the information transmitted, (c) determines whether the information transmitted was received correctly, and observes the received serial symbols over another interval of the frame and repeats steps (b) and (c) whenever the information transmitted was not received correctly. The receiver 1600 may also notify the transmitter that the information transmitted was received correctly whenever the information transmitted was received correctly or alternatively sleep until the next frame whenever the information transmitted was received correctly. The length of the frame will depend on a transmission time rather than the number of symbols or bits in the frame. In addition, the length of the frame can be variable, based on the successful receipt of the channel symbols or bits by the receiver, based on feedback from the receiver, or some other estimation technique. Note that the transmission medium can be a cellular network, a wireless network, an ultra-wide bandwidth (UMB) wireless network or an indoor wireless network and can use any multiplexing scheme, such as TDMA, CDMA or OFDM, etc.

### Multiuser Detection

Multiuser detectors in the conventional CDMA system provide significant capacity performance gain over the matched filter. Multiuser detection utilizes the structure in the multiuser access interference and performs temporal filtering on the received signal to decode users. Verdú proposed the optimum multiuser receiver or maximum-likelihood (ML) receiver in which all users' signals are jointly decoded. The computational complexity of the ML receiver prompted the development of a number of sub-optimal receivers. Among those low complexity sub-optimum receivers, the MMSE receiver maximizes the signal-to-interference ratio (SIR).

The implementation of multiuser detectors in the conventional CDMA system is challenged by their complexities. Their complexities will increase in the present invention (parallel CDMA system) depending on the number of bits of the conventional system over which each bit of the parallel system will be spread. However, in the bit asynchronous conventional system, the observation window spans the whole frame to yield the optimum performance. That will be the case also in the present invention (parallel CDMA system). The only difference is that the cross-correlation matrix in the conventional CDMA system is a sparse matrix which helps in reducing the complexities of those receivers which require the inversion of the crosscorrelation matrix such as the decorrelator and the MMSE receiver. The complexities of the linear multiuser receivers can be reduced by their iterative implementation. Therefore, iterative multiuser receivers can be implemented for the present invention (parallel CDMA system).

The analysis of multiuser receivers is very different in the parallel system than in the conventional system. It is due to the fact that in the parallel system, the spreading sequences of a bit are effected differently by the channel which is not the case in the conventional system. Using SIR as the system performance measure, the linear MMSE receiver and the decorrelator for a large system are analyzed, where the processing gain and the number of users approach infinity, while their ratio is kept fixed. The robustness of linear receivers, such as the MMSE and the decorrelating receivers, are quantified against the near-far problem in chip asynchronous random DS-CDMA systems by developing tight upper and lower bounds on their average near-far resistances.

### OFDM vs Parallel CDMA System (Present Invention)

Orthogonal Frequency Division Multiplexing (OFDM) has recently been able to draw major attention for high speed data communications. OFDM is a multi-carrier digital communication modulation technique. Instead of transmitting over a single channel, OFDM divides the transmission of all data among N different sub-carriers. The data rate for each individual sub-carrier is reduced by a factor of N, however due to the paralleling of N different transmissions, the OFDM scheme preserves the overall transmission rate of the system. Both the OFDM and the present invention (parallel CDMA system) transmit information symbols in parallel through the channel. However, they have many significant differences that will be discussed now.

In a frequency selective fading channel, different sub-carriers in OFDM system will be impaired differently by the channel. As a consequence, the sub-carriers which will be damaged badly will lose their information. To overcome this impurity intruded by the channel, linear transformations are proposed to apply to the OFDM symbols before employing IFFT. Since the wireless channel has multipath, the use of the linear preceding at the transmitter complicates the receiver structure. For the present invention (parallel CDMA system), the RAKE receiver will handle the frequency-selective channel very efficiently. Due to the multipath, both the OFDM and the parallel systems will suffer from inter-frame-interference or inter-block-interference. To eliminate the inter-frame-interference, cyclic prefix is used in the OFDM system, which results in reducing the throughput of the system. This loss is almost 20%. On the other hand, the inter-frame-interference suppression capability of the CDMA systems will be increased due to the use of long spreading sequences in the present invention (parallel CDMA system).

In case of a fast fading channel, the doppler spread causes frequency dispersion in OFDM sub-carriers and hence the sub-carriers may lose the very important inter-carrier orthogonality that leads to inter-carrier interference (ICI). In the present invention (parallel CDMA system), lengthening a symbol over the frame averages the effect of the channel over time which increases the instantaneous received energy of that symbol; see Theorem 2. When the channel varies very rapidly, restoring the orthogonality among the OFDM carriers would be almost impossible that may cause severe performance degradation of the OFDM scheme. Whereas, the present invention (parallel CDMA system) with the proposed DPSK signaling will be robust to this situation. DPSK signaling could be used with OFDM scheme, however, in a dispersive multi-path channel which is more likely to occur in a time varying environment, the performance of the OFDM scheme will not be satisfactory.

From the above discussion, the present invention (parallel CDMA system) is expected to be more robust to the small-scale fading which is based on multipath time delay spread and doppler spread than the OFDM system.

### Joint Transmitter-Receiver Optimization

So far, the assumption is that the coherence time of the channel is less than the frame length. This assumption holds in wireless systems similar to the existing cellular systems. However, in indoor wireless, such as Wireless LAN, the multi-path channel could vary significantly slower than the frame length. For this environment, the present invention (parallel CDMA system) can be implemented by designing jointly optimum transmitter-receiver pairs for users subject to their SIR requirements under the assumption that the transmitters and receivers have the accurate information that they need to operate. The joint transmitter-receiver optimization problem in the present invention (parallel CDMA system) is where one transmitter broadcasts signal to many receivers by using multiple antennas in multipath channels. The optimization will be performed over transmitter signatures sⱼ⁽ⁱ⁾ and receiver filters Φⱼ⁽ⁱ⁾ given by

$${min}_{\{ {s}_{j}^{( i )} \}} {\sum }_{j = 1}^{K} {\sum }_{i = 1}^{β} {‖ {S}_{j}^{( i )} ‖}^{2} s . t . for all j \\ {max}_{{Φ}_{j}^{( i )}} \frac{( {\vert {( {Φ}_{j}^{( i )} )}^{H} {H}_{j} {S}_{j}^{( i )} \vert}^{2} )}{{\sum }_{j = 1}^{K} {\sum }_{i = 1}^{β} {\vert {( {Φ}_{j}^{( i )} )}^{H} {H}_{j} {S}_{j}^{( i )} \vert}^{2} + {σ}^{2} {‖ {Φ}_{j}^{( i )} ‖}^{2} - {\vert {( {Φ}_{j}^{( i )} )}^{H} {H}_{j} {S}_{j}^{( i )} \vert}^{2}} \geq {γ}_{j} \qquad ( 16 )$$

where γⱼ is the minimum SIR requirement of user j. The term i in the superscript is the symbol index. The term Hⱼ is a matrix whose components are functions of parameters of multipath channels from the transmitter to user j and the structure of pulse and filter used by the transmitters.

The jointly optimum transmitter-receiver for the conventional multipath down-link CDMA systems with multiple antennas can be designed by minimizing the total transmitted power of the system via designing optimum transmitter sequences and utilizing linear optimum receivers (MMSE receiver) subject to users' signal-to-interference ratio (SIR) requirements. In the conventional multipath system, to design the optimum transmitter-receiver pairs for users the observation window is extended over the whole frame where the optimum transmitter coefficients of the ith symbol are constrained to be zeros outside the symbol interval [(i−1)T, iT]. Unlike the conventional system, the transmitter of the parallel system is not constrained. As a result, the joint transmitter-receiver optimization problem in the conventional system is a constrained optimization problem with respect to that in the present invention (parallel CDMA system). Similarly, if the transmitter is constrained to use OFDM transmitter sequences, the performance of the optimization algorithm will be sub-optimum with respect to the optimum performance of the present invention (parallel CDMA system). Since, it is always desirable to maximize the system capacity fully, the jointly optimum transmitter-receiver pair for each user in the parallel system must be designed to identify the maximum achievable capacity of the system. After adopting some modification to the algorithm, it can be used to solve the above optimization problem. In the conventional system the optimum linear receiver matches the received transmitter sequences. This result is also expected to be found for the parallel system as well. Reverting this expected result, one can say that in the parallel system, the matched filter is the linear optimum receiver, when optimal spreading sequences and powers will be used at the antenna. Therefore, it is important from theoretical and practical points of view to understand the structure of the optimum transmitters for the matched filter receivers under variety of system circumstances.

In the conventional system, different symbols in a frame observe different interference structure due to the finite length of the frame. As a result, optimum transmitter and receiver structures will be different for different symbols of a user. However, that is not the case in the present invention (parallel CDMA system). On the other hand, the transmitter and receiver structures of one symbol can not be the same as that of the other symbols. Thus it is important to understand thoroughly how the optimum transmitter and receiver structures of one symbol are related to those of another symbol in the frame through the eigenfunctions of the channels. The joint transmitter-receiver optimization problem can be solved by using optimum non-linear receivers such as decision feed-back decorrelator and decision feedback MMSE receiver in the present invention (parallel CDMA system). The present invention is application to many system scenarios, such as “many transmitters to one receiver” and “many transmitters to many receivers”.

Although preferred embodiments of the present invention have been described in detail, it will be understood by those skilled in the art that various modifications can be made therein without departing from the spirit and scope of the invention as set forth in the appended claims.

What is claimed is:

1. A method for transmitting information over a transmission medium, the method comprising the steps of:
receiving a set of serial symbols representing the information to be transmitted during a frame;
encoding the set of serial symbols into one or more sets of parallel channel symbols; and
transmitting the one or more sets of parallel channel symbols during the frame.

2. The method as recited in claim 1, wherein the step of receiving a set of serial symbols representing the information to be transmitted during a frame comprises the steps of:
receiving a set of serial bits; and
encoding the set of serial bits into a set of serial symbols representing the information to be transmitted during the frame.

3. The method as recited in claim 1, wherein the step of encoding the set of serial symbols into one or more sets of parallel channel symbols comprises the steps of:
converting the set of serial symbols into one or more sets of parallel symbols; and
encoding the one or more sets of parallel symbols into a transmission channel.

4. The method as recited in claim 1, wherein each symbol is a bit.

5. The method as recited in claim 1, wherein the length of the frame depends on a transmission time.

6. The method as recited in claim 1, wherein the length of the frame is variable.

7. The method as recited in claim 1, wherein the length of the frame is based on successful receipt of the channel symbols.

8. The method as recited in claim 1, wherein the length of the frame is based on feedback from a receiver.

9. The method as recited in claim 1, wherein the transmission medium is a cellular network.

10. The method as recited in claim 1, wherein the transmission medium is a wireless network.

11. The method as recited in claim 1, wherein the transmission medium is an ultra-wide bandwidth wireless network.

12. The method as recited in claim 1, wherein the transmission medium is an indoor wireless network.

13. The method as recited in claim 1, wherein the transmission medium is a TDMA network.

14. The method as recited in claim 1, wherein the transmission medium is a CDMA network.

15. The method as recited in claim 1, wherein the transmission medium is a OFDM network.

16. A method for receiving information over a transmission medium, the method comprising the steps of:
receiving a set of parallel channel symbols during a frame; and
decoding the set of parallel channel symbols into a set of serial symbols representing the information transmitted.

17. The method as recited in claim 16, wherein the step of decoding the set of parallel channel symbols into a set of serial symbols representing the information transmitted comprises the steps of:
(a) observing the received set of parallel channel symbols over an interval of the frame;
(b) decoding the set of parallel channel symbols into a set of serial symbols representing the information transmitted;
(c) determining whether the information transmitted was received correctly; and
(d) observing the received set of parallel channel symbols over another interval of the frame and repeating steps (b) and (c) whenever the information transmitted was not received correctly.

18. The method as recited in claim 17, further comprising the step of notifying the transmitter that the information transmitted was received correctly whenever the information transmitted was received correctly.

19. The method as recited in claim 17, further comprising the step of sleeping until the next frame whenever the information transmitted was received correctly.

20. The method as recited in claim 16, wherein each symbol is a bit.

21. The method as recited in claim 16, wherein the length of the frame depends on a transmission time.

22. The method as recited in claim 16, wherein the length of the frame is variable.

23. The method as recited in claim 16, wherein the length of the frame is based on successful receipt of the channel symbols.

24. The method as recited in claim 16, wherein the length of the frame is based on feedback from a receiver.

25. The method as recited in claim 16, wherein the transmission medium is a cellular network.

26. The method as recited in claim 16, wherein the transmission medium is a wireless network.

27. The method as recited in claim 16, wherein the transmission medium is an ultra-wide bandwidth wireless network.

28. The method as recited in claim 16, wherein the transmission medium is an indoor wireless network.

29. The method as recited in claim 16, wherein the transmission medium is a TDMA network.

30. The method as recited in claim 16, wherein the transmission medium is a CDMA network.

31. The method as recited in claim 16, wherein the transmission medium is a OFDM network.

32. A computer program embodied on a computer readable medium for transmitting information over a transmission medium comprising:
a code segment for receiving a set of serial symbols representing the information to be transmitted during a frame;
a code segment for encoding the set of serial symbols into one or more sets of parallel channel symbols; and
a code segment for transmitting the one or more sets of parallel channel symbols during the frame.

33. The computer program as recited in claim 32, wherein the code segment for receiving a set of serial symbols representing the information to be transmitted during a frame comprises:
a code segment for receiving a set of serial bits; and
a code segment for encoding the set of serial bits into a set of serial symbols representing the information to be transmitted during the frame.

34. The computer program as recited in claim 32, wherein the code segment for encoding the set of serial symbols into one or more sets of parallel channel symbols comprises:
a code segment for converting the set of serial symbols into one or more sets of parallel symbols; and
a code segment for encoding the one or more sets of parallel symbols into a transmission channel.

35. A computer program embodied on a computer readable medium for receiving information over a transmission medium comprising:
a code segment for receiving a set of parallel channel symbols during a frame; and
a code segment for decoding the set of parallel channel symbols into a set of serial symbols representing the information transmitted.

36. The computer program as recited in claim 35, wherein the code segment for decoding the set of parallel channel symbols into a set of serial symbols representing the information transmitted comprises:
(a) a code segment for observing the received set of parallel channel symbols over an interval of the frame;
(b) a code segment for decoding the set of parallel channel symbols into a set of serial symbols representing the information transmitted;
(c) a code segment for determining whether the information transmitted was received correctly; and
(d) a code segment for observing the received set of parallel channel symbols over another interval of the frame and repeating code segments (b) and (c) whenever the information transmitted was not received correctly.

37. The computer program as recited in claim 36, further comprising a code segment for notifying the transmitter that the information transmitted was received correctly whenever the information transmitted was received correctly.

38. The computer program as recited in claim 36, further comprising a code segment for sleeping until the next frame whenever the information transmitted was received correctly.

39. An apparatus for transmitting information over a transmission medium comprising:
an encoder that produces a set of serial symbols representing the information to be transmitted during a frame;
a serial to parallel symbol converter communicably coupled to the encoder;
a modulator communicably coupled to the serial to parallel symbol converter; and
one or more antennas communicably coupled to the modulator.

40. The apparatus as recited in claim 39, wherein each symbol is a bit.

41. The apparatus as recited in claim 39, wherein the length of the frame depends on a transmission time.

42. The apparatus as recited in claim 39, wherein the length of the frame is variable.

43. The apparatus as recited in claim 39, wherein the length of the frame is based on successful receipt of the channel symbols.

44. The apparatus as recited in claim 39, wherein the length of the frame is based on feedback from a receiver.

45. The apparatus as recited in claim 39, wherein the transmission medium is a cellular network.

46. The apparatus as recited in claim 39, wherein the transmission medium is a wireless network.

47. The apparatus as recited in claim 39, wherein the transmission medium is an ultra-wide bandwidth wireless network.

48. The apparatus as recited in claim 39, wherein the transmission medium is an indoor wireless network.

49. The apparatus as recited in claim 39, wherein the transmission medium is a TDMA network.

50. The apparatus as recited in claim 39, wherein the transmission medium is a CDMA network.

51. The apparatus as recited in claim 39, wherein the transmission medium is a OFDM network.

52. An apparatus for receiving information over a transmission medium comprising:
one or more antennas;
a demodulator communicably coupled to the one or more antennas;
a parallel to serial symbol converter communicably coupled to the demodulator; and
a decoder communicably coupled to the parallel to serial symbol converter to produce a set of serial bits representing the information transmitted during a frame.

53. The apparatus as recited in claim 52, wherein the decoder (a) observes the received serial symbols over an interval of the frame, (b) decodes the serial symbols into a set of serial bits representing the information transmitted, (c) determines whether the information transmitted was received correctly, and observes the received serial symbols over another interval of the frame and repeats steps (b) and (c) whenever the information transmitted was not received correctly.

54. The apparatus as recited in claim 53, wherein the apparatus notifies the transmitter that the information transmitted was received correctly whenever the information transmitted was received correctly.

55. The apparatus as recited in claim 53, wherein the apparatus sleeps until the next frame whenever the information transmitted was received correctly.

56. The apparatus as recited in claim 52, wherein each symbol is a bit.

57. The apparatus as recited in claim 52, wherein the length of the frame depends on a transmission time.

58. The apparatus as recited in claim 52, wherein the length of the frame is variable.

59. The apparatus as recited in claim 52, wherein the length of the frame is based on successful receipt of the channel symbols.

60. The apparatus as recited in claim 52, wherein the length of the frame is based on feedback from a receiver.

61. The apparatus as recited in claim 52, wherein the transmission medium is a cellular network.

62. The apparatus as recited in claim 52, wherein the transmission medium is a wireless network.

63. The apparatus as recited in claim 52, wherein the transmission medium is an ultra-wide bandwidth wireless network.

64. The apparatus as recited in claim 52, wherein the transmission medium is an indoor wireless network.

65. The apparatus as recited in claim 52, wherein the transmission medium is a TDMA network.

66. The apparatus as recited in claim 52, wherein the transmission medium is a CDMA network.

67. The apparatus as recited in claim 52, wherein the transmission medium is a OFDM network.

68. A system for transmitting and receiving information comprising:
a transmitter;
a receiver;
a transmission medium communicably coupling the transmitter and the receiver;
the transmitter comprising an encoder that produces one or more sets of parallel channel symbols from a set of serial symbols representing the information to be transmitted during a frame, a serial to parallel symbol converter communicably coupled to the encoder, a modulator communicably coupled to the serial to parallel symbol converter and one or more antennas communicably coupled to the modulator; and
the receiver comprising one or more antennas, a demodulator communicably coupled to the one or more antennas, a parallel to serial symbol converter communicably coupled to the demodulator and a decoder communicably coupled to the parallel to serial symbol converter to produce a set of serial bits representing the information transmitted during the frame.

69. The system as recited in claim 68, wherein the decoder (a) observes the received serial symbols over an interval of the frame, (b) decodes the serial symbols into a set of serial bits representing the information transmitted, (c) determines whether the information transmitted was received correctly, and observes the received serial symbols over another interval of the frame and repeats steps (b) and (c) whenever the information transmitted was not received correctly.

70. The system as recited in claim 69, wherein the receiver notifies the transmitter that the information transmitted was received correctly whenever the information transmitted was received correctly.

71. The system as recited in claim 69, wherein the receiver sleeps until the next frame whenever the information transmitted was received correctly.

72. The system as recited in claim 68, wherein each symbol is a bit.

73. The system as recited in claim 68, wherein the length of the frame depends on a transmission time.

74. The system as recited in claim 68, wherein the length of the frame is variable.

75. The system as recited in claim 68, wherein the length of the frame is based on successful receipt of the channel symbols.

76. The system as recited in claim 68, wherein the length of the frame is based on feedback from a receiver.

77. The system as recited in claim 68, wherein the transmission medium is a cellular network.

78. The system as recited in claim 68, wherein the transmission medium is a wireless network.

79. The system as recited in claim 68, wherein the transmission medium is an ultra-wide bandwidth wireless network.

80. The system as recited in claim 68, wherein the transmission medium is an indoor wireless network.

81. The system as recited in claim 68, wherein the transmission medium is a TDMA network.

82. The system as recited in claim 68, wherein the transmission medium is a CDMA network.

83. The system as recited in claim 68, wherein the transmission medium is a OFDM network.
